(19) United States
(12) Patent Application Publication
(10) Pub. No.: US 2025/0148537 A1
(43) Pub. Date: May 8, 2025

(54) Automated Financial Reporting Error Detector using NLP and ML

(71) Applicant: Joshua Michael Maluchnik, Toledo, OH (US)

(72) Inventor: Joshua Michael Maluchnik, Toledo, OH (US)

(21) Appl. No.: 18/502,009

(22) Filed: Nov. 4, 2023

(51) Int. Cl. G06Q 40/06; G06F 40/40

(52) U.S. Cl. CPC G06Q 40/06; G06F 40/40

(57) ABSTRACT

The present invention is an advanced software platform that masterfully integrates natural language processing (NLP) and machine learning (ML) to achieve superior accuracy in automatically identifying discrepancies in financial documents. Utilizing NLP, the software meticulously analyzes the language within financial texts while ML algorithms enhance its ability to detect anomalies and errors that might be missed during manual checks. This system caters to financial entities, auditors, and companies, significantly improving review processes and guarding against the risks of human oversight. Consequently, it assures the reliability of financial records, bolstering trust in organizations' financial reports, and ensuring adherence to regulatory norms. This breakthrough epitomizes the synergy of financial expertise and cutting-edge technology, redefining standards in financial data verification.

### FIELD OF THE INVENTION

The present invention finds its roots in the rapidly evolving domain of financial technology, commonly referred to as FinTech. Within this broad sphere, the invention carves a distinct niche by focusing on enhancing the accuracy and reliability of financial reporting. Financial reporting, a cornerstone of modern business operations, often grapples with human errors, omissions, and inconsistencies that can lead to significant repercussions both legally and reputationally. Addressing this pressing concern, the invention harnesses advanced computational methodologies to detect and rectify such discrepancies in financial documents. By integrating algorithms, data analytics, and machine intelligence, it automates the traditionally labor-intensive process of reviewing financial statements and ledgers. Beyond mere automation, the invention brings to the table a level of precision and speed that manual reviews cannot match, making it a pioneering effort in marrying finance with the latest technological advancements. This novel approach positions the invention at the forefront of innovations aimed at ensuring financial transparency, accountability, and integrity in an increasingly digitalized business landscape.

### BACKGROUND OF THE INVENTION

In the intricate tapestry of modern business operations, financial reporting emerges as one of the most vital threads. It serves as a transparent reflection of a company's financial health, guiding decisions for stakeholders ranging from investors to regulators. As businesses grow in scale and complexity, so does the intricacy of their financial statements, making the process of ensuring their accuracy increasingly challenging.

Historically, the task of reviewing and verifying these reports fell to human auditors and financial analysts. While their expertise is invaluable, the manual process inherently carries risks. Even the most meticulous professional can overlook subtle discrepancies, given the voluminous nature of such documents and the sheer amount of data they encompass. Such oversights, whether minor or significant, can have cascading consequences. Misrepresentations can mislead stakeholders, erroneous data can result in legal penalties, and any inconsistency can erode the hard-earned trust of investors and partners.

Moreover, as businesses operate in an ever-accelerating world, the prolonged timelines associated with manual review processes further exacerbate the challenges. Delays in verification can hinder timely decision-making, potentially resulting in lost opportunities.

Recognizing these challenges, there has been a growing acknowledgment in the industry of the limitations of relying solely on manual methods. This realization has kindled a quest for more advanced solutions that can not only expedite the review process but also enhance its accuracy. In this backdrop, the pressing demand for a system that seamlessly integrates automation with precision becomes evident. An invention addressing this need would not only revolutionize the domain of financial reporting but also fortify the pillars of transparency, trust, and efficiency in business operations.

### SUMMARY OF THE INVENTION

The invention under discussion represents a cutting-edge fusion of natural language processing (NLP) and machine learning (ML), tailored specifically for the realm of financial reporting. At its core, the system is designed to meticulously comb through financial documents, extracting and interpreting relevant data using advanced NLP techniques. This ensures that the dense financial jargon and complex statement structures are accurately parsed and understood.

But the true innovation lies in its adaptive learning capabilities. By ingesting vast volumes of historical financial data and understanding previously identified discrepancies, the ML algorithms are trained to recognize patterns and anomalies. This means that over time, as the system is exposed to more data and feedback, its predictive accuracy improves, enabling it to preemptively identify potential issues in fresh reports.

Furthermore, the system doesn't just stop at detection. It provides comprehensive feedback, pinpointing the exact location of the inconsistency or anomaly in the report. This ensures that financial professionals can swiftly address the highlighted concerns, leading to more streamlined and efficient workflows.

In essence, this invention marks a paradigm shift in financial report verification. By automating the labor-intensive manual checks and infusing it with the precision of machine intelligence, it promises to significantly reduce errors, bolster the credibility of financial disclosures, and usher in a new era of trust and transparency in the financial world.

### BRIEF DESCRIPTION OF DRAWINGS

The accompanying drawings provide a visual representation of the invention's architectural and operational components. Each figure is tailored to highlight specific functionalities and integrations, offering a comprehensive view of the system's mechanics. While the detailed description provides a textual overview, the drawings serve as a visual aid, enhancing understanding and clarity.

FIG. 1 System Overview Flowchart: This figure offers a holistic view of the system's operation, visualizing the journey from ingesting a financial report to presenting the highlighted discrepancies. Key components, including the Natural Language Processing (NLP) parser, Machine Learning (ML) model, data storage mechanism, and user interface, are delineated to provide a clear understanding of the system's architecture and inter-component interactions.

FIG. 2 Data Input/Output Diagram: This diagram elucidates the transformation process of a financial report as it's processed by the system. It contrasts an exemplar segment of a raw financial report with its subsequent structured format post-NLP processing, illustrating the efficacy of the system's interpretative capabilities.

FIG. 3 NLP Parsing Flowchart: Providing a deep dive into the linguistic analytics, this flowchart details the step-by-step breakdown of financial statements via the NLP parser. From tokenizing sentences to recognizing specific financial terms, it demystifies the methodology employed to deconstruct and understand intricate financial verbiage.

FIG. 4 ML Model Diagram: This figure delineates the intricacies of the ML model, illustrating its architecture—be it a neural network or decision tree—and highlighting its various layers. An adjunct diagram details the model's training process, capturing the continuous data flow, feedback incorporation, and subsequent model optimization.

FIG. 5 Database Structure Diagram: Here, the structural blueprint of the database is presented, spotlighting the systematic storage of historical financial data and recognized discrepancies. This illustration emphasizes the organization of tables, data fields, and the interrelation between diverse datasets.

FIG. 6 Financial Reporting Error Detector Dashboard: This visualization provides a detailed glimpse into the software's graphical user interface. It emphasizes key interaction points, from the central dashboard to report submissions, and integrates features for discrepancy pinpointing and user feedback, offering a comprehensive view of the user's experience.

FIG. 7 Error Detection and Highlight Process: This sequence diagram chronicles the path taken post-discrepancy detection. It traces the system's methodology, from pinpointing the anomaly in the report to its subsequent flagging and presentation to the end user.

FIG. 8 Feedback Loop Diagram: Elaborating on the system's adaptive capabilities, this diagram delves into the iterative feedback process. It showcases the cyclical journey of user feedback incorporation, the model's consequent refinement, and its ensuing enhancements over time.

FIG. 9 System Integration Diagram: Emphasizing the system's interoperability, this comprehensive illustration provides a window into how the primary NLP and ML components collaborate with auxiliary system modules, interface with external databases, or potentially integrate with third-party platforms.

FIG. 10 Security Protocol Architecture: In today's digital landscape, security is paramount. This figure underscores the system's security apparatus, highlighting protocols like data encryption, secure data transmission channels, and other pertinent security mechanisms ensuring data integrity and protection.

### DETAILED DESCRIPTION OF THE INVENTION

The proposed system represents a confluence of cutting-edge technology and user-centered design, poised to revolutionize financial reporting accuracy. At its core, the system operates via a seamless interface meticulously crafted for ease of use. Users, ranging from financial analysts to auditors, can effortlessly upload financial documents or reports into the system. Moreover, for organizations dealing with voluminous or frequent financial reporting, the system provides automated solutions. By leveraging secure and efficient data transfer mechanisms such as SFTP, organizations can schedule and automate the bulk transfer of financial files. Additionally, through API integrations and web connectors, the system can directly interface with other financial software or platforms, fetching real-time data without manual intervention. Web services further augment this capability, allowing for a seamless exchange of data between disparate systems in a standardized manner.

Upon receiving the data, either through manual uploads or automated channels, the Natural Language Processing (NLP) component swiftly swings into action. This component is expertly engineered to dissect complex financial verbiage. Through tokenization, it breaks down the text into individual words or terms. Then, leveraging techniques like entity recognition, it identifies and categorizes distinct financial elements, such as assets, liabilities, revenues, or expenses. By the end of this phase, the otherwise dense financial report is transformed into a structured and machine-readable format.

Following the NLP processing, the data is channeled to the Machine Learning (ML) component. This model stands out due to its rigorous training regimen. It is fine-tuned using vast datasets comprising financial reports, many of which are annotated with known anomalies or discrepancies. This extensive training allows the model to develop a keen acumen in spotting inconsistencies, errors, or unusual patterns in new, unseen reports.

As the ML model combs through the data, it meticulously screens each entry, cross-referencing with its internal knowledge from previous training. Whenever a potential discrepancy is detected, it gets flagged. These flagged entries are then collated and presented in a visually intuitive manner. For enhanced user comprehension, the system generates a concise summary report. This report not only lists the discrepancies but may also offer insights or suggestions based on the nature of the inconsistency.

Furthermore, to ensure continual system enhancement, users are provided with an option to review and give feedback on the detected discrepancies. This feedback mechanism ensures that the system is in a perpetual state of learning and refinement, adapting to evolving financial reporting standards and nuances.

In essence, the system offers a comprehensive solution, amalgamating advanced computational techniques with an intuitive design, aiming to uphold the sanctity and accuracy of financial reports in today's fast-paced business environment.

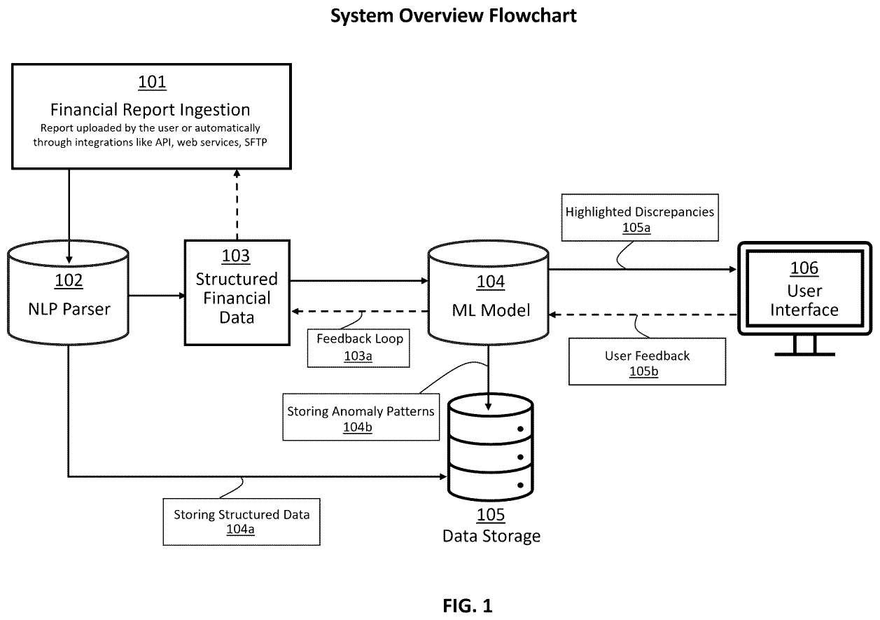

### Description of FIG. 1:

FIG. 1 showcases a complete flowchart that epitomizes the holistic operation of the financial report system, capturing every stage from the ingestion of a financial report to the delivery of highlighted discrepancies.

Initiating at the top is Financial Report Ingestion 101. Here, a rectangle stands distinctly labeled as Financial Report Ingestion. Emerging from this rectangle is a solid arrow guiding downward, signifying the immediate action following the report upload. Notably, a callout juxtaposed near this arrow explicates the means of report acquisition: either uploaded manually by a user or sourced automatically via mechanisms like API, web services, or SFTP.

Subsequently, this leads us to Natural Language Processing (NLP) Parser 102. Represented as a cylinder and labeled as NLP Parser, this is the transformative hub where raw, disparate financial data undergoes a metamorphosis into coherent, structured data. From here, a solid arrow reaches out horizontally towards a box titled Structured Financial Data 103, epitomizing the output of the parsing process. Additionally, a dotted arrow arches back upwards, connecting to the Financial Report Ingestion 101. This portrays the system's flexibility in re-processing data, accommodating any subsequent updates or errors.

Adjacent to this, we encounter the Machine Learning (ML) Model 104, depicted again as a cylinder and marked as ML Model. This is the analytical heart of the system, dedicated to anomaly detection within the structured financial data. Its data flow connection with the Structured Financial Data 103 box is exemplified by a solid arrow. Significantly, an internal dotted arrow (labeled Feedback Loop 103a) within the ML Model demarcates its iterative capacity for learning and refinement.

Positioned below the ML Model 104 is the Data Storage Mechanism 105. Symbolized by a universally recognizable database icon and marked Data Storage, this is the system's repository. It archives both the processed structured data and the patterns/anomalies discerned by the ML Model. The arrows connecting it to the NLP Parser 102 and ML Model 104 are explicitly labeled Storing Structured Data 104a and Storing Anomaly Patterns 104b, respectively, delineating their distinct storage functionalities.

Lastly, on the extremity of the flowchart lies the User Interface 106. Illustrated with a computer screen icon and labeled “User Interface”, this is the terminal through which users interact with the system. A direct arrow, labeled Highlighted Discrepancies 105a, flows from the ML Model 104 to this interface, pinpointing the direction of the system's output. Additionally, a dotted feedback arrow (User Feedback 105b) connects the interface back to the ML Model 104, symbolizing the importance of user feedback in honing the system's efficiency.

In essence, the FIG. 1 System Overview Flowchart meticulously lays out the entirety of the system's architecture, weaving a tapestry of its operational sequence and the intricate interplay between its integral components. The visual dichotomy of solid and dotted arrows accentuates the primary workflows and secondary interactions, rendering a clear and insightful depiction of the system's functionality.

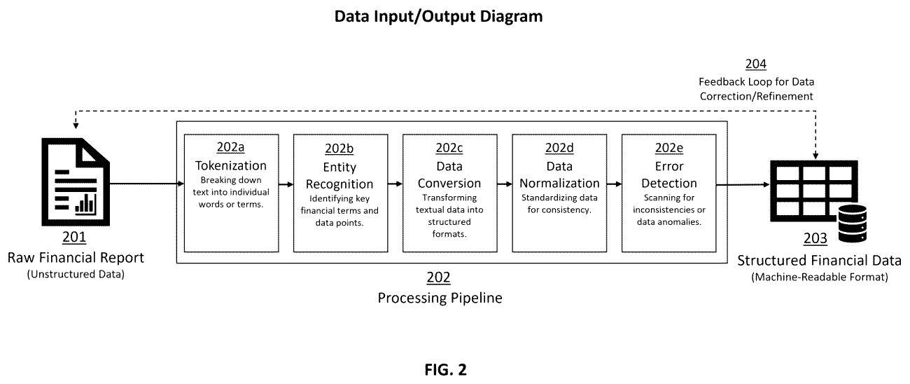

### Description of FIG. 2:

The FIG. 2 Data Input/Output Diagram paints a compelling picture of the transformative journey of raw financial data as it undergoes refinement through the system's sophisticated Natural Language Processing capabilities. The diagram juxtaposes an archetypal segment of an unstructured financial report with its post-processed, structured variant, thereby illustrating the remarkable interpretative prowess of the system.

Starting on the left, we are introduced to Raw Financial Report 201. Visually represented by an iconic paper or document symbol, complete with text lines and perhaps a small pie chart or bar graph, it exudes the essence of a quintessential financial document. This icon is accompanied by a label or text box that clearly announces it as Raw Financial Report—Unstructured Data. Progressing from here, a solid arrow seamlessly directs one's gaze towards the heart of the transformation: the Processing Pipeline 202.

As we transition, we encounter the Processing Pipeline 202, manifested as a prominent rectangle. Nestled within this container are a series of smaller, interconnected rectangles, each elucidating a distinct step in the processing continuum:

Tokenization 202: At this initial juncture, the raw financial report undergoes segmentation, breaking down into individual words or tokens. This is succinctly captured with the annotation: Breaking down text into individual words or terms.

Entity Recognition 202b: Venturing deeper, the system identifies and classifies salient named entities present in the text. These are sorted into predefined categories like financial terms, currencies, and percentages, a process succinctly summarized with the annotation: Identifying key financial terms and data points.

Data Conversion 202c: Here, the previously recognized entities metamorphose into a structured, machine-readable format. For instance, textual representations of percentages or currencies get translated into their numerical counterparts, aptly annotated as Transforming textual data into structured formats.

Data Normalization 202d: To ensure uniformity and consistency, the data might undergo normalization—for example, harmonizing all currency values to a standard like USD or maintaining date format consistency, succinctly annotated as Standardizing data for consistency.

Error Detection 202e: As an added layer of vigilance, the system scrutinizes the processed data for potential anomalies or inconsistencies, captured by the annotation: Scanning for inconsistencies or data anomalies.

These individual processing steps are seamlessly connected with solid arrows, denoting the orderly and sequential flow of data transformation.

On the concluding right side stands the Structured Data Output 203. Symbolized by a table icon, signifying the structured nature of the output, coupled with a database icon, it underscores the idea of structured storage. This is aptly labeled as Structured Financial Data-Machine-Readable Format.

Supplementing this entire process is the Feedback Mechanism 204. Originating from the Structured Data Output, a dotted two-way arrow arches back to the Raw Financial Report, signifying iterative refinement or a feedback loop. This loop, labeled “Feedback Loop for Data Correction/Refinement,” underlines the system's commitment to continuous learning and optimization. Should the structured data reveal any discrepancies, the system is primed to learn, adapt, and refine its processing algorithms for future datasets.

In summation, FIG. 2 offers a vivid, step-by-step visualization of the transformative alchemy performed by the system on raw financial data. By detailing each phase of the process, from initial ingestion to the final structured output, the diagram accentuates the system's methodical approach and capability. The design elements, from arrows to color differentiation, and the annotations work harmoniously to elucidate this complex orchestration, ensuring an intuitive understanding for the viewer.

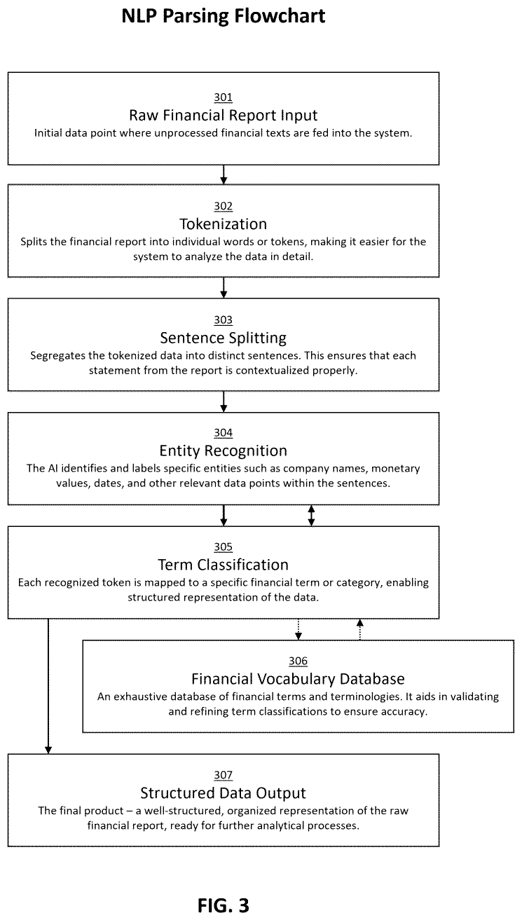

### Description of FIG. 3:

Starting at the top of the diagram, the Raw Financial Report Input box 301 serves as the initial data point where unprocessed financial texts are introduced into the system. A solid arrow flows from this box, directing the raw data towards the Tokenization box 302 positioned directly below it. At this stage, the system methodically splits the financial report into individual words or tokens, laying the foundation for more intricate parsing tasks ahead.

Directly below, the Sentence Splitting box 303 receives the tokenized data. This component is essential as it carefully segregates the tokenized report into distinct sentences, ensuring each financial statement maintains its contextual relevance.

As the parsed data flows further, the Entity Recognition box 304 takes center stage. Positioned below the Sentence Splitting box, this component is designed for precision. It meticulously identifies and labels entities like company names, monetary values, dates, and other salient data points within each sentence. An intricate dance of data movement happens here, symbolized by two arrows. The first arrow flows into the Term Classification box 305, while a two-way arrow establishes an iterative relationship between entity recognition and term classification. This bilateral link underscores the system's adaptive nature, where improvements in one component can reciprocally enhance the other.

The Term Classification box 305 is where the recognized tokens find their designated places. Each token gets diligently mapped to specific financial terms like revenue, assets, or liabilities. But the system doesn't stop here. It engages with an external check, represented by a dotted arrow, against the Financial Vocabulary Database box 306. Positioned slightly off-center, this database acts as the system's guardian of financial vernacular, housing an exhaustive list of financial terms. The system harnesses this resource to validate and refine its term classifications, a process manifested by a feedback loop, symbolized by a second dotted arrow looping back from the database box.

Lastly, we reach the culmination of this intricate dance of data in the Structured Data Output box 307. Located at the very bottom, it's the testament to the system's prowess. It showcases the raw financial report, now transformed into a coherent, well-structured format, poised for further analytics.

To summarize, FIG. 3 paints a clear picture of the NLP parsing process tailored for financial reports. It masterfully elucidates the sequential steps, their interdependencies, and the sophisticated methodology behind understanding and structuring complex financial verbiage. The meticulous design-comprising of different arrows and boxes-offers viewers profound insights into the inner workings of linguistic analytics, driving home the message of precision, adaptability, and thoroughness inherent in the system.

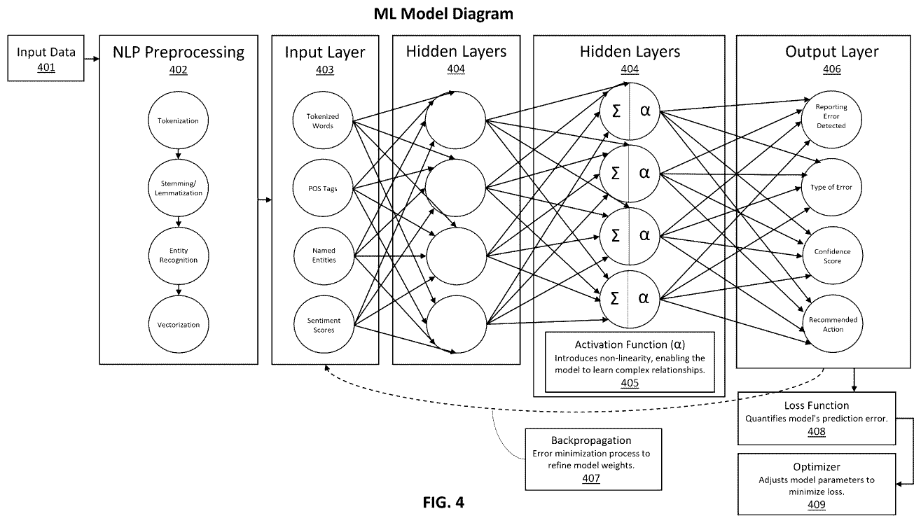

### Description of FIG. 4:

FIG. 4 ML Model Diagram provides an intricate visualization of the Machine Learning (ML) model's architecture, potentially portraying a neural network tailored for automated financial reporting error detection using Natural Language Processing (NLP).

Beginning on the far left of the diagram, the model initiates with an Input Data section 401. An arrow from this section points towards the next component, labeled NLP Preprocessing 402. Here, textual data undergoes a series of essential NLP-specific preprocessing steps housed within a larger container, emphasizing their collective role in data refinement. These steps include:

Tokenization: Here, text is methodically segmented into tokens, be it words, subwords, or sentences, using standard libraries like NLTK or spaCy. This ensures a consistent granularity throughout the dataset.

Stemming/Lemmatization: This process is aimed at simplifying words. While stemming truncates words to their root forms, lemmatization ensures these roots are valid words in their respective language.

Entity Recognition: This step identifies specific entities such as names, places, or organizations, leveraging libraries like spaCy or custom models, if available.

Vectorization: Text is transformed into a numerical format suitable for ML models using techniques ranging from Bag of Words and TF-IDF to advanced embeddings like Word2Vec, GloVe, BERT, or GPT.

Each of these preprocessing steps is visually represented as distinct nodes, with sequential arrows connecting them, depicting the data flow. Upon concluding the preprocessing phase, another arrow links the NLP Preprocessing box 402 to the Input Layer 403.

At the Input Layer 403, the processed data gets fed into the model. This layer's nodes symbolize features derived from financial documents, such as Tokenized Words, POS Tags, Named Entities, and Sentiment Scores. There's also potential for including nodes representing semantic embeddings or vector representations of the input.

Following the input, the diagram exhibits several Hidden Layers 404. These layers consist of vertically aligned circles, the count of which is determined by the model's complexity. Arrows represent connections from every node in one layer to every node in the next, symbolizing the underlying weights and biases in neural processing. Each hidden layer is aptly labeled, for instance, Hidden Layer 1, Hidden Layer 2, and so on.

Within these neurons, a visual division exists to depict a two-phase process labeled as Activation Function 405. The left side, marked with a 2 symbol, calculates a weighted sum of inputs. Meanwhile, the right, marked with an a symbol, signifies the activation function introducing non-linearity into the network, crucial for learning complex relationships. An explanatory textbox elaborates that this function introduces non-linearity, enabling the model to learn complex relationships.

The Output Layer 406 is stationed to the extreme right. Here, vertically aligned circles represent the output neurons, receiving inputs from the last hidden layer. These outputs could range from detecting a reporting error to suggesting corrective actions.

Post-output, the diagram features a Backpropagation & Optimization section 407. A dotted arrow looping back from the output to the input illustrates the backpropagation process, a mechanism to adjust the model's weights based on the error. Accompanying this is a callout elucidating Backpropagation: Error minimization process to refine model weights.

Next, the Loss Function 408 rectangle is strategically placed just below the Output Layer, quantifying the model's prediction error. Following which, the Optimizer 409 sits right underneath the Loss Function 408. It plays a pivotal role in adjusting the model's parameters to minimize the computed loss, potentially using mechanisms like Gradient Descent or the Adam optimizer, as highlighted in an adjacent textbox.

In essence, FIG. 4 ML Model Diagram serves as a comprehensive visual guide, detailing the complex journey from raw textual data to actionable financial reporting insights using NLP and ML techniques.

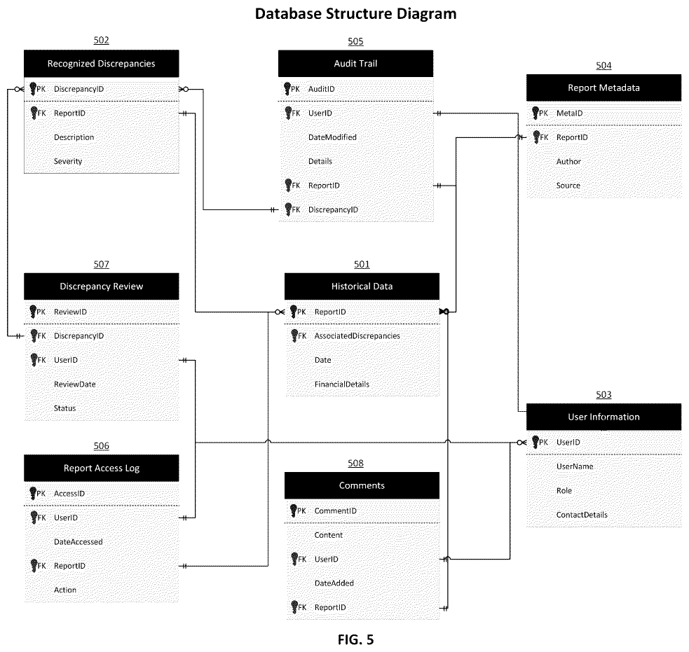

### Description of FIG. 5:

The FIG. 5 Database Structure Diagram offers a comprehensive view into the architectural makeup of a database purposefully designed for the systematic storage of historical financial data and its recognized discrepancies. The diagram deftly unveils the meticulous organization of tables, their inherent data fields, and the intricate web of relationships binding these datasets.

The Historical Data table 501 serves as a cornerstone, harboring fields such as the ‘ReportID,’ a unique identifier for each financial report, ‘Date’ to denote when the report was generated, ‘FinancialDetails’ which is a structured compendium of financial line items and their corresponding values, and ‘AssociatedDiscrepancies’ which acts as a bridge to the Recognized Discrepancies table 502, indicating discrepancies discerned in the associated report.

In parallel, the Recognized Discrepancies table 502 holds the ‘DiscrepancyID’ as its primary key, uniquely identifying each discrepancy. To maintain coherence, it references the ‘ReportID’ from the Historical Data table 501, thus linking each discrepancy to its original report. The table further elaborates on the nature of the discrepancy through the ‘Description’ field and gauges its gravity via the ‘Severity’ metric.

Moving on, the User Information table 503 is pivotal in storing stakeholder details. It encompasses fields like ‘UserID’ as its primary identifier, ‘UserName’ detailing the full name, ‘Role’ defining the user's capacity such as analyst, auditor, or manager, and ‘ContactDetails’ which is a repository of contact means like email or phone number. A notable highlight adjacent to the ‘Role’ is a callout that demarcates user permissions predicated on their roles, such as analysts being restricted to merely viewing the data.

The Report Metadata table 504, designed to store auxiliary data about financial reports, is distinguished by fields like ‘MetaID,’ its unique identifier, and ‘ReportID’ which connects it to the main Historical Data table 501. Other prominent fields include ‘Author,’ highlighting the report's creator, and ‘Source,’ signifying the origin of the report.

Further refining this structure, the Audit Trail table 505 is formulated to encapsulate modifications to financial reports or discrepancies. It encompasses the ‘AuditID’ as its unique tag, ‘UserID’ to pinpoint the user initiating the modification, ‘DateModified’ indicating when the change was made, and ‘Details’ offering a thorough account of the alterations. Crucially, this table has ties with both the Historical Data table 501 through ‘ReportID’ and the Recognized Discrepancies table 502 via ‘DiscrepancyID’ to denote which entity was altered.

Additionally, the Report Access Log table 506 stands out by diligently recording every instance a report is accessed. It does so through the ‘AccessID,’ its primary key, ‘UserID’ to determine the accessing user, ‘DateAccessed’ as the timestamp, ‘ReportID’ for referencing the specific report in the Historical Data table 501, and ‘Action’ to specify activities like viewing, downloading, or sharing.

The Discrepancy Review table 507 delves deeper into the audit process of discrepancies. Fields include the ‘ReviewID,’ its unique identifier, ‘DiscrepancyID’ linking to the reviewed discrepancy, ‘UserID’ denoting the reviewer, ‘ReviewDate’ signifying when the review was done, and ‘Status’ offering outcomes like resolved, pending, or escalated.

Lastly, the Comments table 508, carved to capture stakeholder inputs, comprises the ‘CommentID’ as its unique tag, ‘Content’ relaying the actual comment, ‘UserID’ identifying the commentator, ‘DateAdded’ indicating when it was inserted, and ‘ReportID’ tying it to a specific report in the Historical Data table 501.

Connecting these tables in the Crow's foot database notation for FIG. 5 are relationship connectors, ensuring each table gracefully references pertinent details from its counterparts. Such meticulous interlinking guarantees robust database integrity and optimal functionality.

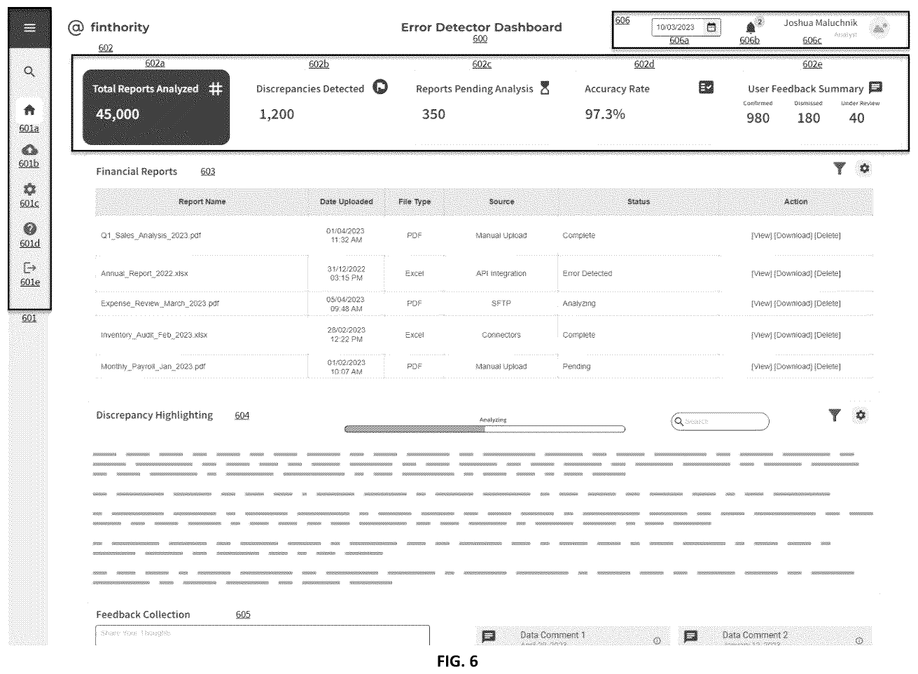

### Description of FIG. 6:

To encapsulate, FIG. 6 Financial Reporting Error Detector Dashboard presents a sophisticated interface meticulously designed to cater to the needs of financial professionals. The dashboard primarily begins with the Main Dashboard Window 600, characterized by its sizable rectangular framework, crowned by the title, Financial Reporting Error Detector Dashboard.

Directly aligned to the left is the Navigation Bar 601, which hosts various intuitive icons such as the Home icon 601a, an emblematic house symbol directing users back to the landing page. The bar continues with the Manual Report Upload icon 601b, characterized by an arrow within a cloud for manual uploads, Configuration Settings icon 601c, a cog indicating settings, Assistance icon 601d with a question mark for user support, and the Logout Option 601e, portraying an exit door for logging out.

Occupying the top part of the dashboard is the Data Overview Panel 602, offering a condensed view of key metrics. This panel comprises counters for Total Reports Analyzed 602a, Discrepancies Detected 602b, Reports Pending Analysis 602c, and Accuracy Rate 602d. Additionally, it provides a User Feedback Summary 602e delineating the feedback status for detected discrepancies.

Centrally positioned is the Financial Reports Table 603, a robust space enabling users to review their uploaded financial documents. With interactive sorting, searching, and pagination features, this table ensures a fluid user experience.

Following is the Discrepancy Highlighting 604 section, ingeniously designed to spotlight any inconsistencies in the reports. Equipped with heatmaps, NLP and ML indicators, highlighted texts, and on-hover features, it serves as the pivot between raw data and actionable insights.

Finally, to the right or below, depending on design preference, the Feedback Collection Mechanism 605 stands as the embodiment of user-system interaction. With its bi-directional arrows, feedback forms, acknowledgment system, and incentivization strategies, this section fosters continuous system refinement.

Conclusively, FIG. 6 offers an expansive and interactive overview of the Financial Reporting Error Detector Dashboard, ensuring an efficient, engaging, and effective user experience.

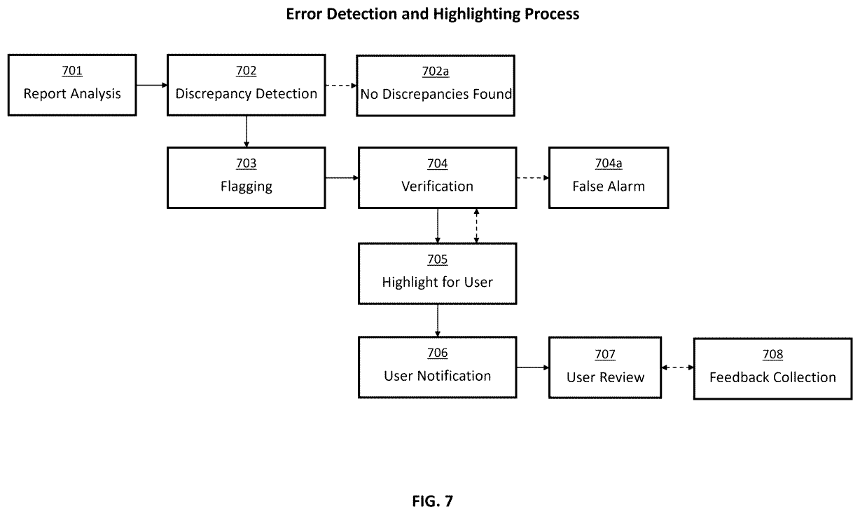

### Description of FIG. 7:

In FIG. 7, titled Error Detection and Highlight Process, the sequential progression of actions taken post-discrepancy detection in a report is visually represented. The diagram commences with Report Analysis 701, located at the top-left. Upon the system's ingestion of a report, it initiates an analytical assessment. From this stage, a solid arrow directs the data flow rightwards, pointing to the subsequent step, Discrepancy Detection 702. Here, the system deploys its algorithms to scrutinize the report, seeking any inconsistencies. When the system discerns a potential discrepancy, the flow is directed downwards via a solid arrow to the Flagging 703 step. Conversely, if no inconsistencies are discerned, a dotted arrow veers off to an endpoint box labeled No Discrepancies Found 702a.

The Flagging 703 component is strategically situated beneath Discrepancy Detection 702. At this juncture, any identified inconsistency is flagged, necessitating further scrutiny. This flagged data is then channeled to the Verification 704 stage, as shown by a solid arrow pointing to the right. During this verification phase, a meticulous analysis is undertaken to corroborate if the flagged data genuinely constitutes an inconsistency. Two possible outcomes emerge post-verification: a solid arrow directing the flow to Highlight for User 705 confirms the existence of a discrepancy. In contrast, a dotted arrow diverging towards a box labeled False Alarm 704a indicates the data, upon validation, is accurate.

The Highlight for User 705 phase is positioned to directly below Verification 704. In this stage, the authenticated discrepancy is readied for presentation to the end user. A bidirectional dotted arrow between this step and Verification 704 symbolizes the potential for iterative refinements in the system's highlighting approach, emanating from its continuous learning capability. The next logical action, indicated by a downward-pointing solid arrow, progresses to User Notification 706. Here, the user is apprised of the detected inconsistency. Specific modalities of this notification—whether they manifest as in-app alerts, emails, or other communication mechanisms—are delineated through various callouts within this section. Following this alert, an arrow ushers the process to User Review 707.

The User Review 707 stage, situated to the right of User Notification 706, grants the user the opportunity to peruse the emphasized inconsistency. A bidirectional dotted arrow interlinks this step with Feedback Collection 708, signaling the potential for iterative adaptations based on user insights. Lastly, Feedback Collection 708, positioned even further to the right, is where the system accumulates user reactions regarding the highlighted inconsistencies. Pertinent callouts in this region can elucidate the modes of feedback submission and elucidate the system's capacity to adapt and evolve based on the feedback garnered.

Overall, FIG. 7 is meticulously structured to guide the viewer through a coherent flow of processes. The interplay of solid and dotted arrows adeptly differentiates between indispensable processes and those that are conditional or optional. The design prioritizes clarity, ensuring that the visual representation remains uncluttered, with annotations and callouts judiciously arranged to maximize comprehension.

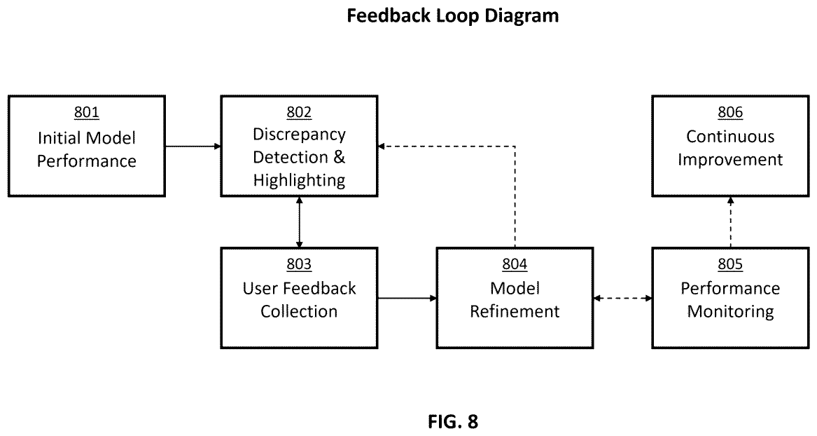

### Description of FIG. 8:

FIG. 8, labeled Feedback Loop Diagram, illustrates the system's ability to evolve and improve iteratively through the incorporation of user feedback into its operational model. This diagram underscores the ongoing process by which the system refines its performance in detecting discrepancies within reports, leveraging real-world usage and feedback to enhance its accuracy and reliability over time.

At the beginning of the loop, Initial Model Performance 801 is positioned at the top-left corner, signifying the baseline competency of the model to identify discrepancies based on its preliminary training dataset. From this point, a solid arrow indicates the flow to the right, toward the Discrepancy Detection & Highlighting 802 stage. This phase is the crux of the model's function, where it actively identifies and illuminates possible discrepancies for the user's consideration.

Adjacent to this, and linked by a two-way arrow, is User Feedback Collection 803, which is directly below Discrepancy Detection & Highlighting 802. This connection signifies a dynamic channel through which the system collects and reacts to user feedback on its discrepancy detection efforts. The feedback may encompass various types, such as identification of false positives or undetected discrepancies, and could detail the mechanisms via which users submit their feedback.

Following the collection of feedback, a solid arrow leads to Model Refinement 804, situated to the right of the feedback stage. This critical juncture is where the system assimilates the user-provided insights, adjusting and fine-tuning its algorithms accordingly to improve its detection capabilities. Within this stage, the system may employ advanced methods such as reinforcement learning or algorithmic fine-tuning, as noted in potential text boxes within the section.

Significantly, a dotted arrow loops from Model Refinement 804 back to Discrepancy Detection & Highlighting 802, encapsulating the iterative essence of the model's enhancement process. This indicates that the system undergoes continuous evolution, recalibrating its performance based on new data and insights gained from its users.

Performance Monitoring 805, positioned further to the right, is where the system's performance is methodically observed following the integration of user feedback. Callouts in this phase could delineate the specific metrics used to gauge the model's performance or establish benchmarks that signal the need for additional refinement.

The diagram culminates at Continuous Improvement 806, located at the top-right, which is the epitome of the model's evolution—an ever-improving entity that becomes increasingly proficient with each iteration of feedback and refinement. The journey from Performance Monitoring 805 to this final stage is denoted by a dotted arrow, reinforcing the perpetual nature of the model's advancement.

Overall, FIG. 8 Feedback Loop Diagram is meticulously designed to convey a clear and continuous cycle of improvement. It illustrates the system's inherent adaptability and its capacity for self-enhancement through an iterative feedback mechanism. Arrows—especially those that loop back—serve a pivotal role, symbolizing the ongoing, never-ending process of advancement. The diagram is intended to be uncluttered, with callouts and annotations judiciously placed to enrich understanding without overwhelming the viewer.

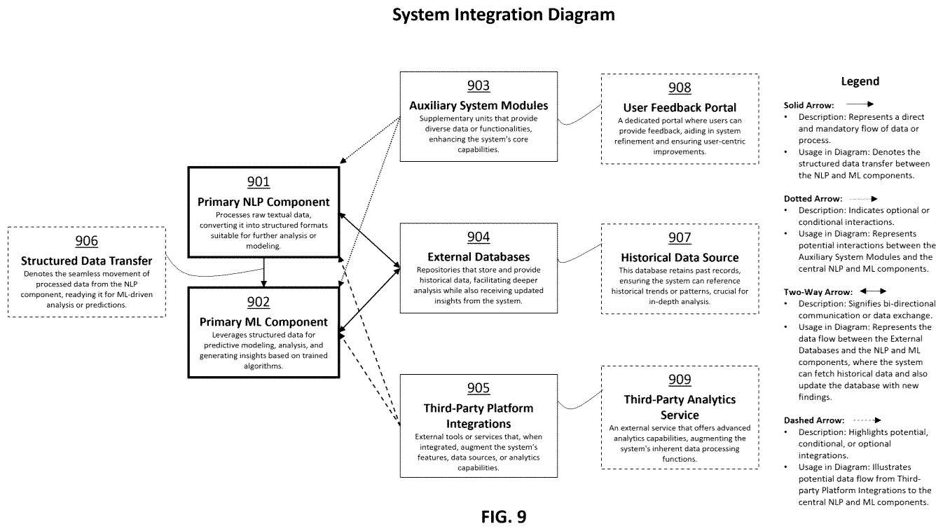

### Description of FIG. 9:

The FIG. 9 System Integration Diagram is designed to articulate the interoperability of the system by demonstrating how the foundational Natural Language Processing (NLP) and Machine Learning (ML) components synergize with various ancillary modules, interface with external databases, and how they have the potential to integrate with third-party platforms.

At the heart of the diagram, the Primary NLP Component 901 and the Primary ML Component 902 are represented as thicker nodes, underscoring their pivotal roles within the system. The Primary NLP Component 901 is responsible for processing raw textual data, transforming it into a structured format that is amenable to further analysis or modeling. On the other hand, the Primary ML Component 902 employs the structured data provided by the NLP component to carry out predictive modeling, analysis, and to generate insights based on the algorithms it has been trained on. The critical interaction between these two components is depicted with a solid arrow, indicating a direct and necessary data flow from the NLP to the ML component for subsequent analysis.

Surrounding these core components are the Auxiliary System Modules 903, depicted with dotted arrows connecting to both the NLP and ML components. These arrows suggest that while the auxiliary modules may contribute additional data or functionality, their interaction is not constant but optional or conditional, depending on specific use cases or system requirements. These modules serve to bolster the primary functions of the system, providing a rich tapestry of data and capabilities that extend the system's core features.

The External Databases 904 are shown with two-way arrows to indicate a robust, bidirectional exchange of information. This interaction illustrates the system's ability to draw upon historical data for processing and simultaneously contribute back by updating the databases with new insights or refined information. Such a relationship ensures the system benefits from a comprehensive historical context, which is essential for in-depth analysis and informed decision-making.

Further expanding the system's reach are the Third-party Platform Integrations 905 shown with dashed arrows. These arrows indicate potential integration points with external tools or services that could augment the system's existing features, provide additional data sources, or enhance its analytics capabilities. The direction of the arrows suggests the data flow towards the central components, emphasizing the intake of new data or functionalities from these platforms.

Elaborating on these interactions, additional callouts such as Structured Data Transfer 906 clarify the importance of the processed data's movement from the NLP to the ML components. The Historical Data Source 907 callout connects to the External Databases 904, stressing the significance of historical data in the system's analytical processes. The User Feedback Portal 908 emphasizes the role of user input in refining the system, while Third-Party Analytics Service 909 highlights the potential for external analytics services to bolster the system's data processing capabilities.

Completing the diagram, a legend precisely defines the meaning of each arrow type, establishing a clear understanding of the various data flows and their implications:

Solid arrows represent the mandatory flow of data from NLP to ML components.

Dotted arrows suggest conditional interactions with Auxiliary System Modules.

Two-way arrows indicate a dynamic exchange with External Databases.

Dashed arrows illustrate potential integrations with Third-party Platforms.

In its entirety, FIG. 9 details a system that is not only robust in its core functionality but is designed to evolve and integrate seamlessly within a broader ecosystem of data sources and analytical tools. This integration diagram effectively communicates the system's architectural sophistication and highlights its adaptability, making it an invaluable asset for stakeholders looking to leverage cutting-edge NLP and ML technologies.

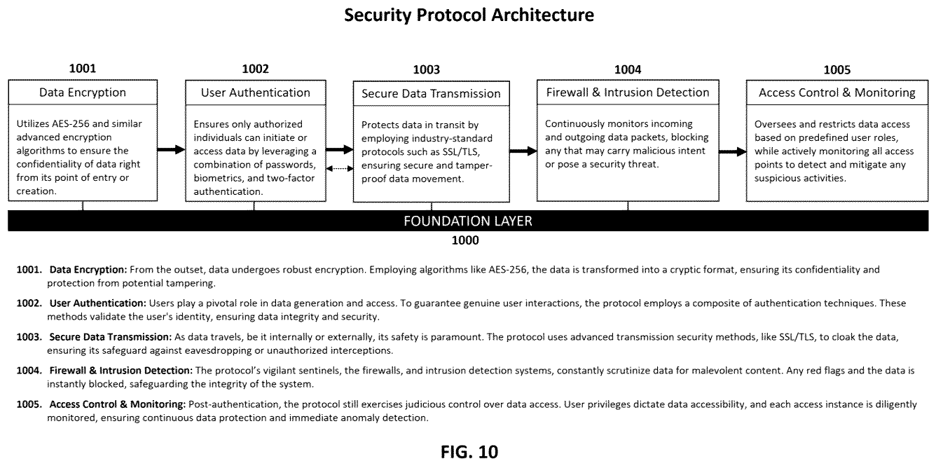

### Description of FIG. 10:

The FIG. 10 Security Protocol Architecture offers a comprehensive visualization of the stringent security measures employed to maintain data integrity and security throughout its lifecycle within the system. The diagram unfolds linearly across a horizontal plane, enabling a clear, step-by-step interpretation of data flow from the moment it enters the system to its ultimate secure storage.

At the foundation of this architecture is the Foundation Layer 1000, which extends the full width of the diagram. This foundational baseline underpins every other security component, signifying the data's journey and the sequential application of security protocols. It's depicted as a shaded continuum, reflecting the structured, interconnected nature of the security processes, from data inception to secure storage, and how each one builds upon the last to create a cohesive and comprehensive security strategy.

The initiation of data into the system is protected by Data Encryption 1001. Situated on the left side of the diagram, this box introduces the first layer of defense, utilizing sophisticated encryption algorithms such as AES-256 to transform data into a secure format, ensuring confidentiality from the get-go. A solid, bold arrow leads from this component to the next, indicating the transition from data encryption to user authentication.

Following encryption is User Authentication 1002, a critical security gatekeeper ensuring that only verified users can access or initiate data transfer. This component is visualized to the right of the Data Encryption 1001 box, denoting its subsequent role in the security sequence. Authentication is achieved through a mix of passwords, biometric verification, and two-factor authentication processes, creating a robust barrier against unauthorized access. Solid arrows indicate the progression towards secure data transmission, while dotted two-way arrows represent the credential exchanges necessary during authentication and data transfer.

Centrally located in the diagram is Secure Data Transmission 1003. This phase of the architecture ensures the secure passage of data, protected against interception or tampering, using proven protocols such as SSL/TLS. Data is encrypted in transit, safeguarded by these protocols as indicated by annotations detailing their use, and a solid arrow points to the next phase, depicting the data's onward journey after its secure transmission.

The system's defense against external threats is embodied in Firewall & Intrusion Detection 1004. Placed to the right of the Secure Data Transmission 1003 box, it highlights the continuous monitoring for threats and the proactive measures taken to block malicious data packets. This component is linked by a solid arrow from the Secure Data Transmission 1003 phase, showcasing the natural progression to stringent data packet analysis and threat mitigation.

Completing the process is Access Control & Monitoring 1005, found at the end of the data journey. Here, data access is regulated based on user roles and privileges, with ongoing monitoring to promptly identify and address any aberrations. This terminal component is the last line of defense in the architecture, emphasizing the ongoing oversight and proactive monitoring that characterizes the system's approach to security.

Below the visual sequence of the diagram, annotations provide further clarity on each component's role and importance. From initial encryption to user authentication, secure transmission, threat detection, and finally, access control and monitoring, each annotation elucidates the critical functions of the security layers, reinforcing the diagram's demonstration of a robust and multi-layered security protocol.

In summary, FIG. 10 delivers a detailed roadmap of the security protocol architecture. It charts out the systematic, layered approach to securing data, with each phase meticulously designed to protect against vulnerabilities and unauthorized access, thereby illustrating the protocol's unwavering dedication to data integrity and the safeguarding of information within the system.

1. A software solution capable of automatically detecting anomalies in financial reports using natural language processing.

2. A method where the parsed financial data from claim 1 is converted into a structured format for easier analysis.

3. A system designed with a user interface that allows for easy uploading and reviewing of financial reports.

4. The system as claimed in claim 1, wherein machine learning models are employed to enhance detection accuracy based on historical data.

5. The system as claimed in claim 1, which offers users a summarized report of detected inconsistencies.

6. The system as claimed in claim 3, that incorporates features for uploading financial reports via various methods including API, web services, and SFTP.

7. The method as claimed in claim 2, wherein financial data is classified and segregated according to predefined categories.

8. The system as claimed in claim 1, which includes an adaptive learning mechanism that refines anomaly detection processes over time.

9. The system as claimed in claim 1, where the anomaly detection is facilitated by a combination of both rule-based and probabilistic approaches.

10. The system as claimed in claim 3, including feedback mechanisms allowing users to rectify and address the detected anomalies.

11. The system as claimed in claim 1, with a built-in alert system that notifies users upon detection of critical inconsistencies in financial data.

12. The system as claimed in claim 3, that provides user access controls and role-based permissions for various functionalities.

13. The system as claimed in claim 2, that employs normalization and standardization techniques for the input financial data.

14. The system as claimed in claim 1, which integrates with external financial databases or third-party interfaces for additional data validation.

15. The system as claimed in claim 3, with encryption and secure data transmission protocols ensuring data safety.

16. The method as claimed in claim 2, where the structured format assists in comparative financial analysis over different periods.

17. The system as claimed in claim 4, that maintains a repository of historical discrepancies to facilitate the machine learning model's training.

18. The system as claimed in claim 6, that automates the ingestion of financial data at predefined intervals.

19. The system as claimed in claim 1, which can be deployed across various platforms including cloud, on-premises, and hybrid environments.

20. The method as claimed in claim 2, where additional metadata is generated to provide context to the structured financial data.
